(19) United States
(12) Patent Application Publication
(10) Pub. No.: US 2010/0095842 A1
(43) Pub. Date: Apr. 22, 2010

(54) REMOVAL OF CARBON DIOXIDE FROM AIR

(76) Inventors: Klaus S. Lackner, Dobbs Ferry, NY (US); Ping Liu, Tucson, AZ (US)

Correspondence Address: HAYES SOLOWAY P.C., 3450 E. SUNRISE DRIVE, SUITE 140, TUCSON, AZ, 85718, US

(21) Appl. No.: 12/515,259

(22) PCT Filed: Nov. 15, 2007
(86) PCT No.: PCT/US07/84880

§ 371 Date: Dec. 29, 2009

Related U.S. Application Data
(60) Provisional application No. 60/866,020, filed on Nov. 15, 2006.

(51) Int. Cl. B01D 53/62; B01J 20/34

(52) U.S. Cl. 95/107; 502/22; 502/56

(57) ABSTRACT

A process for removing CO₂ from the air, comprising the steps of (a) passing the air in contact with a first ion exchange resin to absorb CO₂ from the air; (b) passing a CO₂ sorbent in contact with the first ion exchange resin to transport CO₂ to the sorbent; passing the sorbent from step (b) in contact with a weak base anion exchange resin to absorb CO₂ from the sorbent; separating the CO₂ from the ion exchange resin by heating the ion exchange resin from step (c) whereby to drive off the CO₂ from the resin. Alternatively, the ion exchange resin may be washed with water prior to heating.

The present application claims priority from U.S. Provisional Application Ser. No. 60/866,020, filed Nov. 15, 2006, the contents of which are incorporated herein by reference.

The present invention relates to removal of selected gases from air. The invention has particular utility for the extraction of carbon dioxide (CO₂) from air and will be described in connection with such utilities, although other utilities are contemplated.

There is compelling evidence to suggest that there is a strong correlation between the sharply increasing levels of atmospheric CO₂ with a commensurate increase in global surface temperatures. This effect is commonly known as Global Warming. Of the various sources of the CO₂ emissions, there are a vast number of small, widely distributed emitters that are impractical to mitigate at the source. Additionally, large scale emitters such as hydrocarbon-fueled power plants are not fully protected from exhausting CO₂ into the atmosphere. Combined, these major sources, as well as others, have lead to the creation of a sharply increasing rate of atmospheric CO₂ concentration. Until all emitters are corrected at their source, other technologies are required to capture the increasing, albeit relatively low, background levels of atmospheric CO₂. Efforts are underway to augment existing emissions reducing technologies as well as the development of new and novel techniques for the direct capture of ambient CO₂. These efforts require methodologies to manage the resulting concentrated waste streams of CO₂ in such a manner as to prevent its reintroduction to the atmosphere.

The production of CO₂ occurs in a variety of industrial applications such as the generation of electricity power plants from coal and in the use of hydrocarbons that are typically the main components of fuels that are combusted in combustion devices, such as engines. Exhaust gas discharged from such combustion devices contains CO₂ gas, which at present is simply released to the atmosphere. However, as greenhouse gas concerns mount, CO₂ emissions from all sources will have to be curtailed. For mobile sources the best option is likely to be the collection of CO₂ directly from the air rather than from the mobile combustion device in a car or an airplane. The advantage of removing CO₂ from air is that it eliminates the need for storing CO₂ on the mobile device.

Extracting carbon dioxide (CO₂) from ambient air would make it possible to use carbon-based fuels and deal with the associated greenhouse gas emissions after the fact. Since CO₂ is neither poisonous nor harmful in parts per million quantities, but creates environmental problems simply by accumulating in the atmosphere, it is possible to remove CO₂ from air in order to compensate for equally sized emissions elsewhere and at different times.

Various methods and apparatus have been developed for removing CO₂ from air. For example, we have recently disclosed methods for efficiently extracting carbon dioxide (CO₂) from ambient air using capture solvents that either physically or chemically bind and remove CO₂ from the air. A class of practical CO₂ capture sorbents include strongly alkaline hydroxide solutions such as, for example, sodium or potassium hydroxide, or a carbonate solution such as, for example, sodium or potassium carbonate brine. See for example published PCT Application PCT/US05/29979 and PCT/US06/029238.

Some prior art methods include the use of a thermal swing to regenerate ion exchange resins. Where these are used to capture CO₂, however, these processes are inefficient, creating additional CO₂ due to the required heat input. See U.S. Pat. No. 4,324,564; and U.S. Pat. No. 6,402,814.

The present invention provides improvements over the prior art as described above. More particularly, the present invention provides several processes and systems for extracting carbon dioxide (or other gases of interest) from air using a primary exchange resin, carrying the extracted carbon dioxide (or other gases of interest) to a secondary resin or sorbent located remote from the primary exchange resin, and regenerating the secondary resin or sorbent.

Further features and advantages of the present invention will be seen from the following detailed description, taken in conjunction with the accompanying drawings, wherein

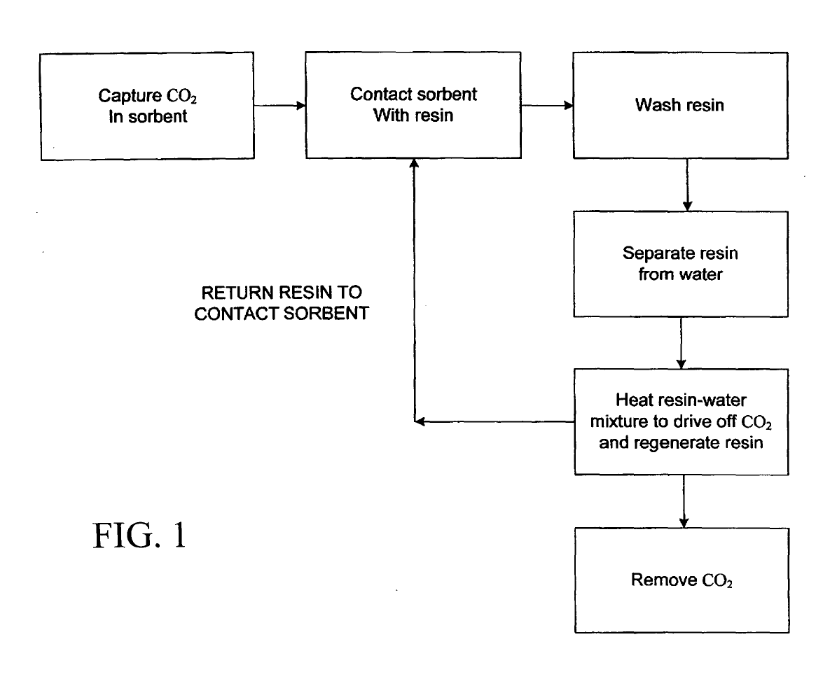

FIG. 1 is a block flow diagram illustrating the present invention; and

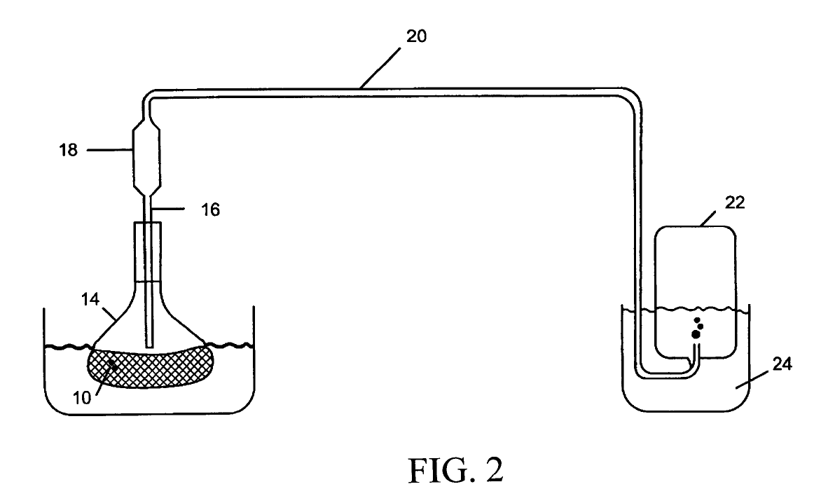

FIG. 2 is a diagrammatic drawing illustrating proof of concept; and

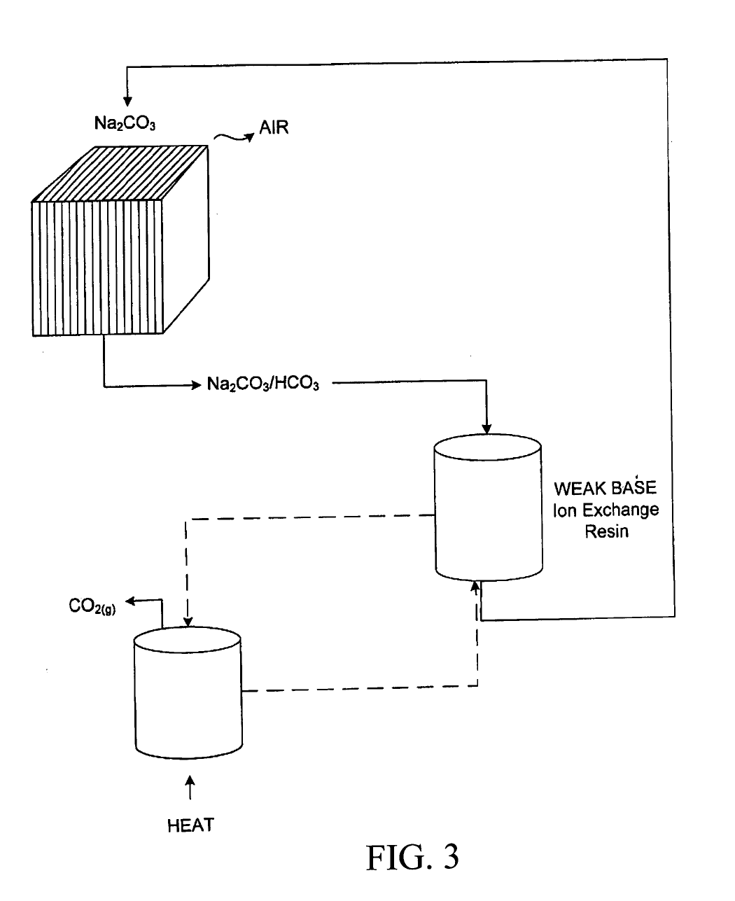

FIG. 3 is a diagrammatic drawing illustrating integration of the present invention with a CO₂ collection device.

The present invention generally relates to carbon dioxide (CO₂) extraction, reduction, capture, disposal, sequestration or storage, particularly from air, and involves new processes and apparatuses to reduce CO₂ gas in the environment. The extracted carbon dioxide can then be (1) sold or traded as an article of commerce and/or (2) converted to carbon credits for sale or trade and/or (3) sequestered in some manner so that it is removed from the atmosphere thereby mitigating its role as a so-called greenhouse gas.

The present invention provides a system, i.e. both a process and an apparatus, for extracting carbon dioxide (CO₂) from air and for regenerating the resin used in the extraction process. It thereby can provide a two-fold economic benefit by regenerating the resin for subsequent use and by delivering a product, namely carbon dioxide, that has commercial value in a number of end-use applications. Furthermore, it can provide ecological benefits arising from the fact that the carbon dioxide so recovered either negates the need for producing a like quantity of that product for commercial purposes, or that the carbon dioxide so recovered can be sequestered from the environment through a number of techniques, e.g., as described in aforesaid PCT Application Nos. PCT/US2005/01543, PCT/US2005/015454, PCT/US2006/03646 and PCT/US2006/029238. The ecological benefits cited above arise from the characterization of carbon dioxide as a major greenhouse gas and thereby an assumed primary contributor to climate change, specifically global warming.

The present invention effects the extraction of carbon dioxide from air using a primary resin. The extracted carbon dioxide is then carried to a secondary resin or sorbent located remote from the primary resin, and the secondary resin or sorbent is regenerated, e.g. chemically or electrochemically, or by application of heat to the carbon dioxide loaded resin, i.e., resin with carbon dioxide or its constituent ions chemically and/or physically bound to it. For example, using heat swing as a regeneration mechanism, at a temperature of about 40° C., carbon dioxide gas begins to be released by the resin and emitted therefrom. The release of carbon dioxide gas at this temperature is a useful feature of strong-based ion exchange resins which may be used in a CO₂ gas extraction process which typically lose all or a portion of their efficacy at the temperatures required to free bound CO₂. Since the preferred operating temperature is in the range of about 40° C. to 95° C., a weak based ion exchange resin is required. It is the weakly bound nature of the CO₂/weak base ion exchange resin connection which allows the successful separation of CO₂ with the resin at the preferred temperature of 40° C.-95° C. which is below the recommended maximum temperature of this resin type (typically 100°).

The scientific literature, for example Huang and Chang, Energy & Fuels 2002, 16, 904-910, describes the use of weakly basic ion exchange resins containing amine functional groups to regenerate ammonia through absorbing carbonic acid at ambient temperatures from ammonium bicarbonate, the main product formed by the absorption of CO₂ by ammonia. The resin is then regenerated by heating in water at temperatures in the 50° C. to 100° C. range, resulting in release of ammonia.

The utility of the present invention is not constrained by the manner in which the CO₂ or its constituent ions are affixed to the ion exchange resin. However, for the purposes of illustration of the novelty and usefulness of the present invention, the invention will be described in which the constituent ions were presented to the secondary resin by washing the resin with a 0.5 molar aqueous solution of sodium bicarbonate (NaHCO₃).

The basic concept embodied in this invention permits extraction of CO₂ using a primary resin under as close to ideal conditions as possible. The extracted CO₂ is then carried to a secondary resin or sorbent where the extracted CO₂ is then separated from the secondary resin or sorbent using a more convenient chemistry, electrochemistry, or heat. The overall process is as follows: CO₂ is extracted from air by a primary resin. The extracted CO₂ is then stripped from the primary resin and carried to a secondary resin or sorbent by a carrier solvent, e.g. water or water vapor, or basic solution such as a hydroxide or carbonate solution, or the extracted CO₂ can be stripped from the primary resin by outgassing the CO₂ by subjecting the primary resin to reduced pressure. This leaves the primary resin available to extract more CO₂ from the air. The extracted CO₂ is captured by the secondary resin or sorbent, which is then regenerated using convenient chemical regeneration, electrochemical regeneration or heat. By way of example, in one exemplary embodiment of the invention heat is used to separate carbon dioxide from an ion exchange resin used to achieve separation and recovery of a Na₂CO₃ sorbent from a NaHCO₃ aqueous mixture by passing the NaHCO₃ aqueous mixture in contact with an ion exchange medium. The resin extracts CO₂ from the NaHCO₃ by a acid/base reaction, regenerating Na₂CO₃ which is returned to the upstream process, e.g., in accordance with the teachings of PCT/US2006/029328. The separation of carbon dioxide from the resin typically proceeds by washing the loaded resin with water, separating the resin from the wash water and heating the mixture of resin and entrained water to a temperature and for a duration of heating such that the ion exchange resin remains largely unchanged (other than to release carbon dioxide) over a number of cycles. That is, the efficacy of the resin to extract CO₂ from NaHCO₃ and thereby regenerate Na₂CO₃ remained at an acceptable level following the initial and subsequent periods of heating during which carbon dioxide it had captured and held was released. Furthermore, this may be accomplished without a noticeable change in pressure.

The following working example is given as a proof of concept.

### WORKING EXAMPLE

Referring to FIGS. 1 and 2, a mixture of the ion exchange resin beads 10 were washed with 0.5 molar aqueous solution of NaHCO₃ to simulate a sorbent mixture as would be generated by the process described in PCT/US2006/029238. The resin beads were then washed in deionized water. The wash water was decanted, and the resin beads were centrifuged to remove the bulk of the water remaining thereon. The centrifuged resin beads 10 were then placed in a glass flask 14 configured such that overheads driven from the flask by heating were conveyed via a conduit 16 through a condenser 18. The bulk of the water vapors carried through the condenser 18 from the heated flask 14 condensed in the condenser 18 and was trapped there while the carbon dioxide gas driven off the resin beads 10 was conveyed via a conduit 20 as overheads into a third vessel 22 where the carbon dioxide gas was collected. The resin beads 10 were then removed from flask 14, and returned to service, i.e. to remove carbon dioxide from NaHCO₃ and regenerate Na₂CO₃ sorbent.

Various exchange resins are available commercially and advantageously may be used in the present invention. Particularly preferred are ion exchange resins such as Purolite® A830 available from the Purolite Company of Bala Cynwyd, Pa., Amberlite® IRA67 available from Rohm & Haas, Philadelphia, Pa., and Diaion® 20 and Diaion® 30 available from Mitsubishi Chemical Corporation, Tokyo, Japan. However, other commercially available ion exchange resins advantageously may be employed in accordance with the invention.

Finally in a thermal swing heat is produced in a process that creates its own CO₂, which is also captured. Renewable energy may be used to produce the heat required for regeneration. Alternatively, low cost coal may be used to collect the CO₂ from the combustion process as well. In that case an additional 250 kJ of heat would create an additional ½ mole of CO₂. However, some of the energy cost could be avoided in a heat recovery system. Thus, for every liter of solution heated, there is another liter of solution cooled. In this manner, most of the heat can be recovered.

While the invention has been described in connection with the extraction of CO₂ from air, the invention advantageously may be employed to extract other desirable gases such as NO_{R}, H₂S etc. Also, one or more additional secondary resin beds or sorbents may be added in series.

A feature and advantage of the present invention permits extraction of CO₂ from the air using a primary resin under as close to ideal conditions as possible. The extracted CO₂ can then be carried from the primary air exchanger to a secondary exchange bed or apparatus designed specifically for regeneration of the resin. The resin in the primary bed and the resin in the secondary bed may be the same or different resins.

While the invention has been described in connection with a preferred embodiment employing a thermally sensitive ion exchange resin material for extracting CO₂ from ambient air, advantages with the present invention may be realized by extracting carbon dioxide from ambient air using a sorbent in accordance with the several schemes described in our aforesaid PCT Application Nos. PCT/US05/29979 and PCT/US06/029238, and releasing the extracted CO₂ into a greenhouse by suitably manipulating the sorbent. Moreover, while deionized water was used as a wash water for the carbon dioxide loaded resin in the above example, a basic (pH>7) wash water solution advantageously may be used. Further embodiments and uses not explicitly discussed here are contemplated by the applicant and will be apparent to one having skill in the relevant art.

1: A process for removing CO₂ from the air, comprising the steps of:
(a) passing the air in contact with a first ion exchange resin to absorb CO₂ from the air;
(b) passing a CO₂ sorbent in contact with the first ion exchange resin to transport CO₂ to the sorbent;
(c) passing the sorbent from step (b) in contact with a weak base anion exchange resin to absorb CO₂ from the sorbent; and
(d) separating the CO₂ from the ion exchange resin by heating the ion exchange resin from step (c) to drive off the CO₂ from the resin.

2: The process of claim 1, wherein the ion exchange resin comprises a solid anion exchange material.

3: The process of claim 1, wherein the ion exchange resin is coated on a substrate or embedded or otherwise integrated into a carrier material.

4: The process of claim 1, including the step of washing the ion exchange resin with water, and separating the resin from the water prior to heating the resin.

5: The process of claim 4, wherein the water comprises deionized water.

6: The process of claim 4, wherein the water comprises a basic (pH>7) water solution.

7: The process of claim 1, wherein the ion exchange resin is heated to above about 40° C.

8: The process of claim 7, wherein the ion exchange resin is heated to a temperature in the range of 50° to 95° C.

9: A process for regenerating an ion exchange resin used to remove CO₂ from a sorbent solution comprising a carbonate/bicarbonate mixture, comprising the steps of:
(a) passing the sorbent solution in contact with an ion exchange resin to transfer CO₂ from the sodium bicarbonate solution to the resin;
(b) washing the ion exchange resin from step (a) and water; and
(c) separating the CO₂ from the ion exchange resin by heating the ion exchange resin from step (b) to drive off CO₂ from the resin.

10: The process of claim 9, wherein the ion exchange resin comprises a solid anion exchange material.

11: The process of claim 9, wherein the ion exchange resin is coated on a substrate or embedded or otherwise integrated into a carrier material, e.g. a polymeric membrane.

12: The process of claim 9, including the step of separating the resin from the water prior to heating the resin.

13: The process of claim 12, wherein the water comprises deionized water.

14: The process of claim 12, wherein the water comprises a basic (pH>7) water solution.

15: The process of claim 9, wherein the ion exchange resin is heated to above about 40° C.

16: The process of claim 15, wherein the ion exchange resin is heated to a temperature in the range of 50° to 95° C.

17: A process for separating carbon dioxide held on or within an ion exchange resin, which comprises heating the ion exchange resin to drive off the carbon dioxide.

18: The process of claim 17, wherein the ion exchange resin is heated to a temperature in excess of about 40° C.

19: The process of claim 18, wherein the ion exchange resin is heated to a temperature in the range of 50° to 95° C.

20: The process of claim 1, wherein the ion exchange resin comprises a weak base ion exchange resin or a weakly basic ion exchange resin.

21: The process of claim 1, wherein the ion exchange resin is in the form of beads.

22: The process of claim 21, wherein the ion exchange resin beads are crushed before use.

23: A process for removing a selected trace gas from the air, comprising the steps of:
(a) passing the air in contact with a first resin bed to absorb the selected trace gas from the air;
(b) transporting the absorbed selected trace gas to a second resin bed to absorb the selected trace gas on the second resin bed; and
(c) separating the selected trace gas from the second resin bed by heating the second resin bed to drive off the selected trace gas from the resin.

24: The process of claim 23, wherein the first resin bed and the second resin bed both comprise solid anion exchange materials.

25: The process of claim 23, wherein the first and or second resins are coated on a substrate or embedded or otherwise integrated into a carrier material.

26: The process of claim 23, including the step of washing the first resin bed with water, or steam.

27: The process of claim 26, wherein the water comprises deionized water.

28: The process of claim 26, wherein the water comprises a basic (pH>7) water solution.

29: The process of claim 23, wherein the second resin bed is heated to above about 40° C.

30: The process of claim 29, wherein the second resin bed is heated to a temperature in the range of 50° to 95° C.

31: The process of claim 24, wherein the first resin bed and the second resin bed are formed of the same exchange materials.

32: The process of claim 23, wherein the first and second resin beds comprise weak base ion exchange resins or weakly basic ion exchange resins.

33: The process of claim 23, wherein the first and second resins are in the form of beads.

34: The process of claim 33, wherein the resin beads are crushed before use.

35: The process of claim 23, wherein the trace gas is CO_{2.}

36: The process of claim 23, wherein the second resin bed includes a sorbent for the selected trace gas.

37: The process of claim 36, wherein the sorbent is regenerated electrochemically.
